(19) United States
(12) Patent Application Publication
(10) Pub. No.: US 2019/0335070 A1
(43) Pub. Date: Oct. 31, 2019

(54) LENS MODULE AND METHOD FOR ASSEMBLING THE SAME

(71) Applicants: TRIPLE WIN TECHNOLOGY(SHENZHEN) CO.LTD., Shenzhen (CN); HON HAI PRECISION INDUSTRY CO., LTD., New Taipei (TW)

(72) Inventors: KE-HUA FAN, Shenzhen (CN); SHIN-WEN CHEN, Tu-Cheng,New Taipei (TW); LONG-FEI ZHANG, Shenzhen (CN); KUN LI, Shenzhen (CN)

(21) Appl. No.: 15/979,600

(22) Filed: May 15, 2018

(30) Foreign Application Priority Data
Apr. 28, 2018 (CN) 201810403645.8

(51) Int. Cl. H04N 5/225; G02B 5/20; G02B 7/02

(52) U.S. Cl. CPC H04N 5/2254; G02B 7/025; G02B 5/20; H04N 5/2253

(57) ABSTRACT

A method for assembling a lens module to be free of dust and other pollutants includes providing a circuit board, an image sensor, an optical filter, and a mounting frame. The image sensor is connected to the circuit board. The optical filter is glued to the top side of the mounting frame, and the bottom side of the mounting frame is connected to the circuit board. The optical filter, the mounting frame, and the circuit board define a closed space receiving the image sensor. A lens is mounted in a lens holder to form a lens unit and the lens holder is attached to the circuit board, to position the lens above the image sensor, thereby obtaining the finished lens module.

### FIELD

The subject matter relates to imaging devices.

### BACKGROUND

A lens module comprises a lens, a lens holder, an optical filter, an image sensor, and a circuit board. During assembly, the lens is mounted in the lens holder, and the optical filter is glued to the lens holder containing the lens. After the image sensor is glued on the circuit board, the lens holder containing the lens and the optical filter is glued to the circuit board, to position the lens above the image sensor. However, before the lens holder containing the lens and the optical filter is glued to the circuit board, the image sensor is exposed to outside environment, which may cause pollution by dust or other particles in the air. When light from the lens arrives at the image sensor to form images, stains may appear in images, thus lowering the imaging quality.

Therefore, there is room for improvement in the art.

### BRIEF DESCRIPTION OF THE DRAWINGS

Implementations of the present technology will now be described, by way of example only, with reference to the attached figures.

FIG. 1 is a flowchart of an embodiment of a method for assembling a lens module.

FIG. 2 is a diagrammatic view of an embodiment of a lens module.

FIG. 3 is an exploded diagram of the lens module of FIG. 2.

FIG. 4 is a cross-sectional view taken along line IV-IV of FIG. 2.

### DETAILED DESCRIPTION

It will be appreciated that for simplicity and clarity of illustration, where appropriate, reference numerals have been repeated among the different figures to indicate corresponding or analogous components. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

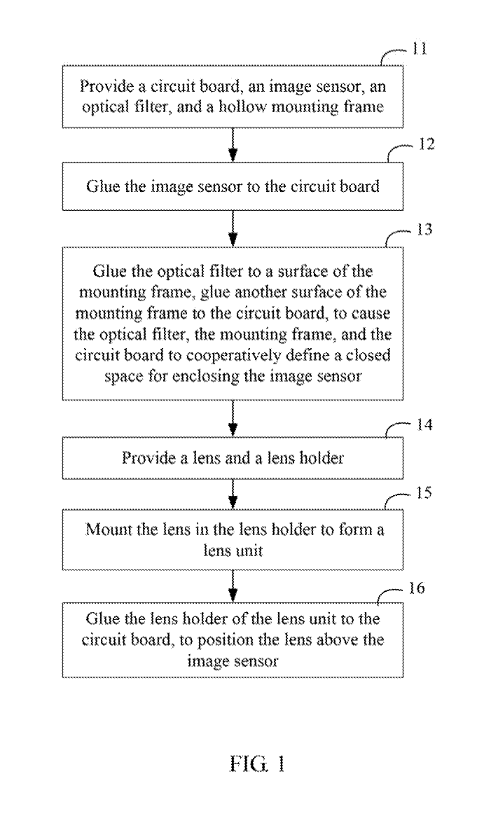

FIG. 1 illustrates an embodiment of a method for assembling a lens module. The method is provided by way of example, as there are a variety of ways to carry out the method. Each block shown in FIG. 1 represents one or more processes, methods, or subroutines, carried out in the example method. Furthermore, the illustrated order of blocks is illustrative only and the order of the blocks can change. Additional blocks can be added or fewer blocks may be utilized, without departing from this disclosure. The example method can begin at block 11.

At block 11, a circuit board 10, an image sensor 20, an optical filter 30, and a hollow mounting frame 40 are provided.

In at least one embodiment, the circuit board 10 is a printed circuit board, for example, a rigid board, a flexible board, or a rigid-flexible board. The circuit board 10 has a connector 11 on one surface, and a plurality of electronic components 12 on another opposite surface. The circuit board 10 can support the electronic components 12 and provide connections for the electronic components 12.

In at least one embodiment, the mounting frame 40 is substantially square, and has four first sides 41 connected end-to-end. The first sides 41 cooperatively define a receiving hole 42. A width of the receiving hole 42 is greater than a width of the image sensor 20.

In at least one embodiment, the image sensor 20 can be a Complementary Metal Oxide Semiconductor (CMOS) sensor or a Charge Coupled Device (CCD) sensor.

At block 12, the image sensor 20 is glued to the circuit board 10 through a first adhesive layer 21.

In at least one embodiment, the image sensor 20 is glued to the surface of the circuit board 10 having the electronic components 12.

In at least one embodiment, a size of the first adhesive layer 21 is substantially equal to a size of the image sensor 20.

At block 13, the optical filter 30 is glued to a surface of the mounting frame 40 through a second adhesive layer 31, and another surface of the mounting frame 40 is glued to the circuit board 10 through a third adhesive layer 43, to enclose the receiving hole 42 with the optical filter 30 and the circuit board 10. Then, the optical filter 30, the mounting frame 40, and the circuit board 10 cooperatively define a closed space 101 for enclosing the image sensor 20.

In at least one embodiment, when the mounting frame 40 is glued to the circuit board 10, the electronic components 40 are positioned outside the mounting frame 40.

In at least one embodiment, an edge of each first side 41 of the mounting frame 40 adjacent to the receiving hole 42 is recessed to form a stepped portion 410. The optical filter 30 is glued to the stepped portion 410, causing the optical filter 30 to be flush with the mounting frame 40. The optical filter 30 is substantially square. The second adhesive layer 31 is applied as the outline of a square, and comprises four second sides 310 connected end-to-end. The second sides 310 correspond to four edges of the optical filter 30.

In at least one embodiment, the third adhesive layer 43 is applied as the outline of a square, and comprises four third sides 430 connected end-to-end. The third sides 430 correspond to the first sides 41 of the mounting frame 40.

At block 14, a lens 50 and a lens holder 60 are provided.

In at least one embodiment, the lens 50 can be made of resin. The lens holder 60 is hollow, and comprises a square first holder portion 61 and a round second holder portion 62 formed at a side of the first holder portion 61. The first holder portion 61 defines a round first hole 610. The second holder portion 62 extends from an inner wall of the first hole 610. The second holder portion 62 defines a second hole 620 communicating with the first hole 610. The first hole 610 and the second hole 620 cooperatively form a mounting hole 600.

At block 15, the lens 50 is mounted in the lens holder 60 to form a lens unit 70.

In at least one embodiment, the lens 50 is mounted in the mounting hole 600 of the lens holder 60.

At block 16, the lens holder 60 of the lens unit 70 is glued to the circuit board 10 through a fourth adhesive layer 71, to position the lens 50 above the image sensor 20, thereby obtaining the lens module 100.

The first hole 610 can receive the optical filter 30, the mounting frame 40, and the image sensor 20. A size of the closed space 101 (that is, the receiving hole 42) is much smaller than a size of the first hole 610. The closed space 101 is isolated from the first hole 610.

In at least one embodiment, the fourth adhesive layer 71 is applied as the outline of a square, and comprises four fourth sides 710 connected end-to-end. The fourth sides 710 correspond to four edges of the first holder portion 61.

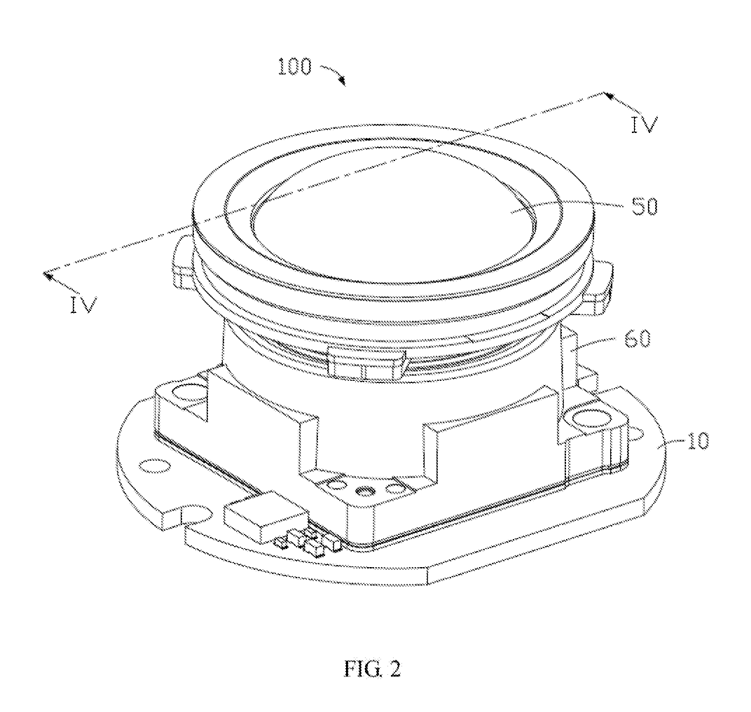

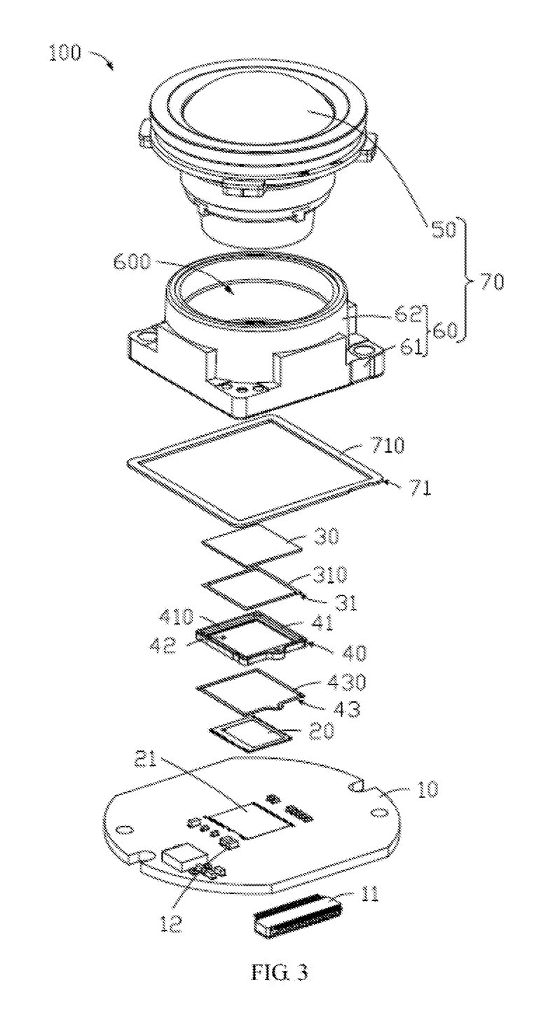

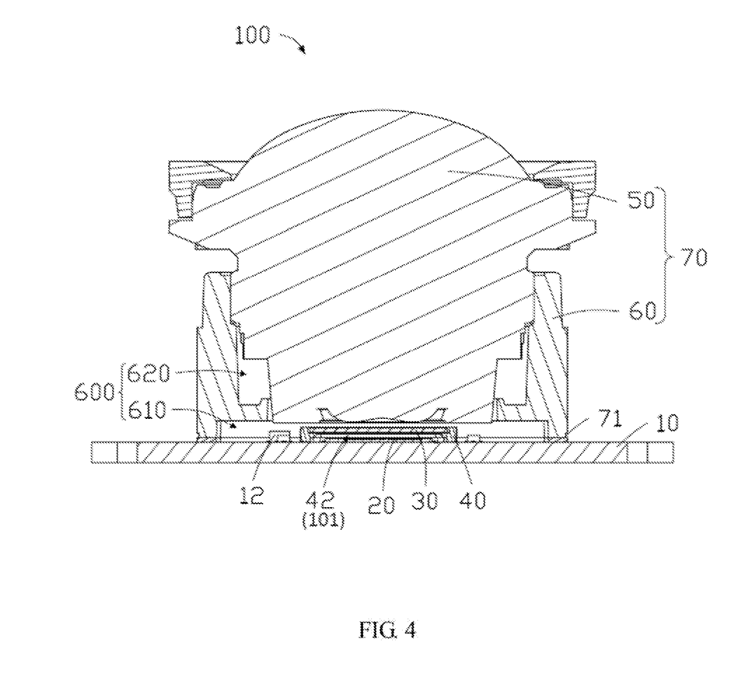

FIGS. 2 to 4 illustrate an embodiment of a lens module 100. The lens module 100 can be applied in an electronic device, such as a smart phone, a tablet computer, or a personal digital assistant (PDA). The lens module 100 comprises a circuit board 10, an image sensor 20, an optical filter 30, a hollow mounting frame 40, and a lens unit 70.

The image sensor 20 is glued to the circuit board 10 through a first adhesive layer 21.

The optical filter 30 is glued to a surface of the mounting frame 40 through a second adhesive layer 31. Another surface of the mounting frame 40 is glued to the circuit board 10 through a third adhesive layer 43, to cause the optical filter 30, the mounting frame 40, and the circuit board 10 to cooperatively define a closed space 101 for receiving the image sensor 20.

The lens unit 70 comprises a lens 50 and a lens holder 60. The lens 50 is mounted in the lens holder 60. The lens holder 60 of the lens unit 70 is glued to the circuit board 10 through a fourth adhesive layer 71, to position the lens 50 above the image sensor 20.

When in use, the optical filter 30 removes infrared light from the light beams passing through the lens 50. The image sensor 20 converts the light beams to electrical signals, and outputs the electrical signals to the circuit board 10. The circuit board 10 processes the electrical signals to form images. The lens module 100 can be mounted to another component of the electronic device through the connector 11.

With the above configuration, the image sensor 20 is received in the closed space 101 before the lens holder 60 is glued to the circuit board. The optical filter 30 and the mounting frame 40 cover the top of the sidewalls of the image sensor 20. Thus, the image sensor 20 is protected from outside environment and dust and other particles in the air cannot pollute the image sensor 20. Furthermore, the closed space 101 having a small size and being isolated from the first hole 610 prevents dust and other particles in the first hole 610 from polluting the image sensor 20. Any dust or other particles falling on the optical filter 30 can be cleaned off by wiping the optical filter 30. Moreover, the mounting frame 40 can prevent any incident light reflected from the electrical components 12 from travelling to the image sensor 20. Thus, light flaring in the lens module 10 is avoided.

Depending on the embodiment, certain of the steps of method hereinbefore described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

Even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present exemplary embodiments, to the full extent indicated by the plain meaning of the terms in which the appended claims are expressed.

What is claimed is:

1. A method for assembling a lens module, comprising:
providing a circuit board, an image sensor, an optical filter, and a hollow mounting frame;
connecting the image sensor to the circuit board;
connecting the optical filter to a surface of the mounting frame, connecting another surface of the mounting frame to the circuit board, to cause the optical filter, the mounting frame, and the circuit board to cooperatively define a closed space for enclosing the image sensor;
providing a lens and a lens holder, mounting the lens in the lens holder to form a lens unit; and
connecting the lens holder of the lens unit to the circuit board, to position the lens above the image sensor.

2. The method of claim 1, wherein the image sensor is glued to the circuit board through a first adhesive layer, the optical filter is glued to the mounting frame through a second adhesive layer, and the mounting frame containing the optical filter is glued to the circuit board through a third adhesive layer, and the lens holder is glued to the circuit board through a fourth adhesive layer.

3. The method of claim 2, wherein the mounting frame has four first sides connected end-to-end, the first sides cooperatively define a receiving hole, a width of the receiving hole is greater than a width of the image sensor, the receiving hole is enclosed with the optical filter and the circuit board to form the closed space.

4. The method of claim 3, wherein an edge of each first side of the mounting frame adjacent to the receiving hole is recessed to form a stepped portion, the optical filter is glued to the stepped portion, causing the optical filter to be flush with the mounting frame.

5. The method of claim 3, wherein the third adhesive layer comprises four third sides connected end-to-end, the third sides correspond to the first sides of the mounting frame.

6. The method of claim 3, wherein the circuit board has a plurality of electronic components on one surface, the image sensor is glued to the surface of the circuit board having the plurality of electronic components, when the mounting frame is glued to the circuit board, the plurality of electronic components is positioned outside the mounting frame.

7. The method of claim 2, wherein the optical filter is square, the second adhesive layer comprises four second sides connected end-to-end, the second sides correspond to four edges of the optical filter.

8. The method of claim 2, wherein the lens holder comprises a square first holder portion and a round second holder portion formed at a side of the first holder portion, the first holder portion defines a round first hole, the second holder portion extends from an inner wall of the first hole, the second holder portion defines a second hole communicating with the first hole, the first hole and the second hole cooperatively form a mounting hole for receiving the lens, the first hole receives the optical filter, the mounting frame, and the image sensor, a size of the closed space is smaller than a size of the first hole.

9. The method of claim 8, wherein the fourth adhesive layer comprises four fourth sides connected end-to-end, the fourth sides correspond to four edges of the first holder portion.

10. A lens module comprising:
a circuit board;
an image sensor connected to the circuit board;
a hollow mounting frame;
an optical filter connected to a surface of the mounting frame, another surface of the mounting frame connected to the circuit board, to cause the optical filter, the mounting frame, and the circuit board to cooperatively define a closed space for receiving the image sensor; and
a lens unit comprises a lens holder and a lens mounted in the lens holder, the lens holder of the lens unit connected to the circuit board, to position the lens above the image sensor.

11. The lens module of claim 10, wherein the image sensor is glued to the circuit board through a first adhesive layer, the optical filter is glued to the mounting frame through a second adhesive layer, and the mounting frame containing the optical filter is glued to the circuit board through a third adhesive layer, and the lens holder is glued to the circuit board through a fourth adhesive layer.

12. The lens module of claim 11, wherein the mounting frame has four first sides connected end-to-end, the first sides cooperatively define a receiving hole, a width of the receiving hole is greater than a width of the image sensor, the receiving hole is enclosed with the optical filter and the circuit board to form the closed space.

13. The lens module of claim 12, wherein an edge of each first side of the mounting frame adjacent to the receiving hole is recessed to form a stepped portion, the optical filter is glued to the stepped portion, causing the optical filter to be flush with the mounting frame.

14. The lens module of claim 12, wherein the third adhesive layer comprises four third sides connected end-to-end, the third sides correspond to the first sides of the mounting frame.

15. The lens module of claim 12, wherein the circuit board has a plurality of electronic components on one surface, the image sensor is glued to the surface of the circuit board having the plurality of electronic components, when the mounting frame is glued to the circuit board, the plurality of electronic components is positioned outside the mounting frame.

16. The lens module of claim 11, wherein the optical filter is square, the second adhesive layer comprises four second sides connected end-to-end, the second sides correspond to four edges of the optical filter.

17. The lens module of claim 11, wherein the lens holder comprises a square first holder portion and a round second holder portion formed at a side of the first holder portion, the first holder portion defines a round first hole, the second holder portion extends from an inner wall of the first hole, the second holder portion defines a second hole communicating with the first hole, the first hole and the second hole cooperatively form a mounting hole for receiving the lens, the first hole receives the optical filter, the mounting frame, and the image sensor, a size of the closed space is smaller than a size of the first hole.

18. The lens module of claim 17, wherein the fourth adhesive layer comprises four fourth sides connected end-to-end, the fourth sides correspond to four edges of the first holder portion.
